(19) United States
(12) Patent Application Publication
(10) Pub. No.: US 2023/0421644 A1
(43) Pub. Date: Dec. 28, 2023

(54) REWARD BASED INTELLIGENT SOCIAL NETWORKING SYSTEM AND METHOD

(71) Applicant: FELO SOCIAL INC., Middletown, DE (US)

(72) Inventors: Sidharth KASI, Hyderabad (IN); Elvis Edwin RODRIGUES, Hyderabad (IN)

(73) Assignee: FELO SOCIAL INC., Middletown, DE (US)

(21) Appl. No.: 18/215,161

(22) Filed: Jun. 27, 2023

Related U.S. Application Data
(60) Provisional application No. 63/355,922, filed on Jun. 27, 2022.

(51) Int. Cl. H04L 67/306; G06Q 50/00; H04L 67/50; G06Q 20/06

(52) U.S. Cl. CPC H04L 67/306; G06Q 50/01; H04L 67/535; G06Q 20/065; G06Q 2220/00

(57) ABSTRACT

The present invention provides a method and reward based intelligent social networking system for providing customized content on the user feed. The intelligent social networking system constantly reviews the content uploaded by user and displays it on the user's feed based on his/her interest. The system further tracks all the activities performed by the user on the platform and attaching NFT and unique hash to the activities performed by the user on the platform, thereby rewarding the user through digital asset, while maintaining user's interest. The present invention also provides a method and a system to block the content which is not approved in that country.

### CROSS-REFERENCE

This application claims the benefit of priority to U.S. Provisional Application No. 63/355,922, filed Jun. 27, 2022, which is incorporated herein by reference.

### FIELD OF THE INVENTION

The present disclosure relates to a social networking environment, and more particularly, provides a system and method for providing a social networking platform to improve the quality of online social interactions among users.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

At present, there are multiple social media platforms available that a user can browse. While such social media platforms vary in their approach to online interactions between users, social media platforms generally provide features through which users can share information and interact with a broader collection of users on the platform. For example, users on social media platforms can post content which is then distributed to other users on the social media platform. Such distribution of content among users can be non-private, in that, the content is broadcast among a broad group of users, which may include people without any sort of social connection to the posting user.

As a result, the user may have to view content that is not relevant to him or her. Also, the user may sometime be not interested in viewing a particular type of content, such as content disliked by the user, content which is not approved by the country of residence of the user, and the like.

Therefore, in light of the aforementioned drawbacks and several other inherent in the existing social media platform, there exists a need to provide an intelligent social networking platform which not only dynamically curates the content and feed according to the need of the user.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

In an embodiment of the present invention, a system for customizing content on a user feed associated with a user profile in a social networking environment is disclosed. The system includes a memory and at least one processor in communication with the memory. The at least one processor is configured to determine a set of parameters associated with the user profile, based on a response of a pre-defined set of questions from a user associated, with the user feed, during a registration of the user profile. The at least one processor is configured to determine a user interest associated with the user profile based on the set of parameters for customizing the user feed, wherein the user interest indicates a content type for promoting a user interaction with the user feed associated with the social networking environment. The at least one processor is configured to correlate the user interest and the content in the social networking environment. The at least one processor is configured to determine a customized content corresponding to the user profile, based on the correlation such that the customized content is selected from the content in the social networking environment in association with the user interest; and displaying the customized content on the user feed associated with the user profile.

In another embodiment of the present invention, a method for customizing content on a user feed associated with a user profile in a social networking environment is disclosed. The method includes determining a set of parameters associated with the user profile, based on a response of a pre-defined set of questions from a user associated with the user feed, during a registration of the user profile. The method includes determining a user interest associated with the user profile based on the set of parameters for customizing the user feed, wherein the user interest indicates a content type for promoting a user interaction with the user feed associated with the social networking environment. Further, the method includes correlating the user interest and the content in the social networking environment. Further, the method includes determining a customized content corresponding to the user profile, based on the correlation such that the customized content is selected from the content in the social networking environment in association with the user interest; and displaying the customized content on the user feed associated with the user profile.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a block diagram depicting schematically an environment of implementation of a system for customizing content on a user feed associated with a user profile in a social networking environment, according to an embodiment of the present disclosure;

FIG. 2a illustrates a schematic block diagram of the system for customizing content on the user feed, according to an embodiment of the present disclosure;

FIG. 2b illustrates another schematic block diagram of modules of the system for customizing content on the user feed, according to an embodiment of the present disclosure;

FIG. 3 illustrates a detailed process flow depicting a method for customizing content on the user feed associated with the user profile in the social networking environment, according to an embodiment of the present disclosure;

FIG. 4 illustrates a detailed process flow depicting a method for converting at least one reward point into a cryptocurrency, according to an embodiment of the present disclosure;

FIG. 5 illustrates a detailed process flow comprising sub-steps of the method step for computing an interest percentage corresponding to the user profile, according to an embodiment of the present disclosure;

FIG. 6 illustrates a detailed process flow depicting a method for displaying updated customized content on the user feed, according to an embodiment of the present disclosure;

FIG. 7 illustrates an exemplary process flow comprising a method for displaying the customized content on the user feed associated with the user profile in the social networking environment, according to an embodiment of the present disclosure; and

FIG. 8 illustrates an exemplary process flow comprising a method for converting at least one reward point into a digital currency, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of the ordinary skilled in the art to which this invention belongs. The system, methods, and examples provided herein are illustrative only and not intended to be limiting.

For example, the term “some” as used herein may be understood as “none” or “one” or “more than one” or “all.” Therefore, the terms “none,” “one,” “more than one,” “more than one, but not all” or “all” would fall under the definition of “some.” It should be appreciated by a person skilled in the art that the terminology and structure employed herein is for describing, teaching, and illuminating some embodiments and their specific features and elements and therefore, should not be construed to limit, restrict, or reduce the spirit and scope of the present disclosure in any way.

For example, any terms used herein such as, “includes,” “comprises,” “has,” “consists,” and similar grammatical variants do not specify an exact limitation or restriction, and certainly do not exclude the possible addition of one or more features or elements, unless otherwise stated. Further, such terms must not be taken to exclude the possible removal of one or more of the listed features and elements, unless otherwise stated, for example, by using the limiting language including, but not limited to, “must comprise” or “needs to include.”

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more element is required.”

Unless otherwise defined, all terms and especially any technical and/or scientific terms, used herein may be taken to have the same meaning as commonly understood by a person ordinarily skilled in the art. Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure. Embodiments of the present invention will be described below in detail with reference to the accompanying drawings.

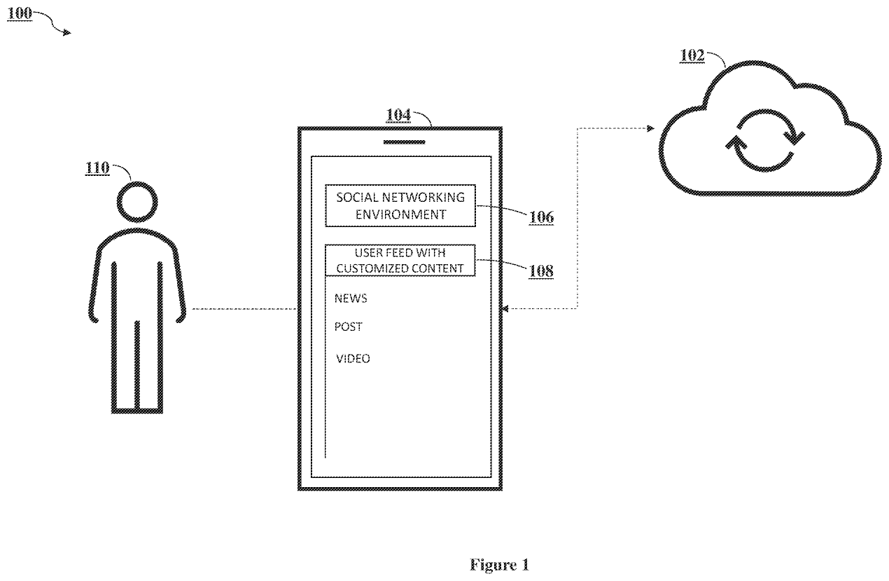

FIG. 1 illustrates a block diagram depicting an environment 100 of implementation of a system for customizing content on a user feed 108 associated with a user profile in a social networking environment 106, according to an embodiment of the present disclosure.

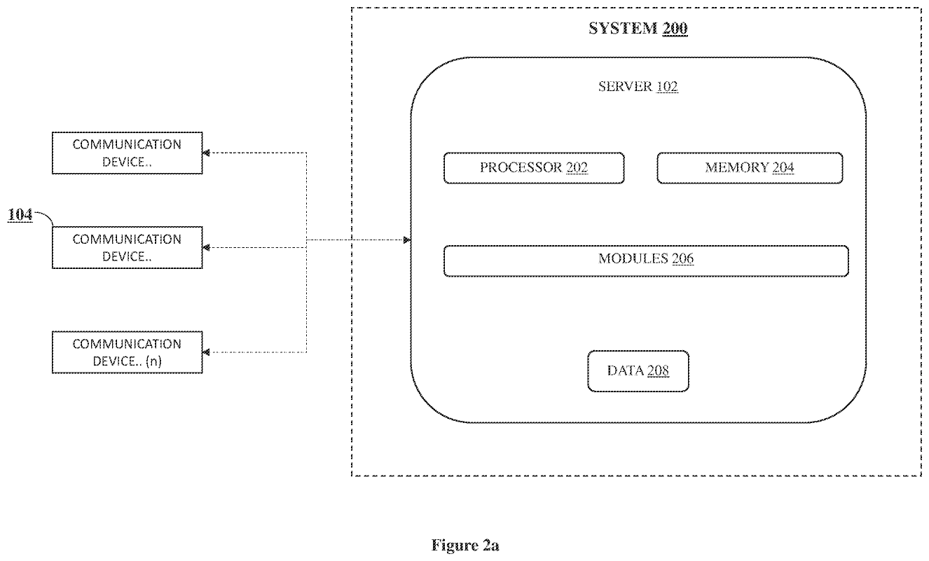

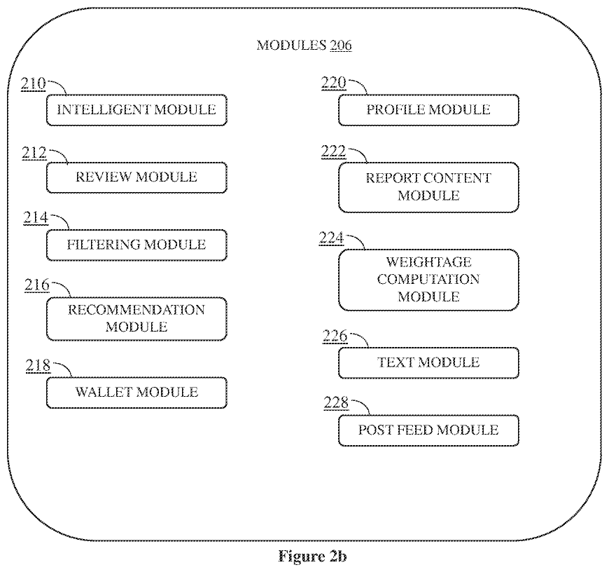

FIG. 2a illustrates a schematic block diagram of a system 200 for customizing the content on the user feed 108, according to an embodiment of the present disclosure. FIG. 2b illustrates another schematic block diagram of modules 206 of the system 200 for customizing the content on the user feed 108, according to an embodiment of the present disclosure. For the sake of brevity, the system 200 for customizing the content on the user feed 108 is hereinafter interchangeably referred to as ‘the system 200.’

In an embodiment, the system 200 may be comprise a server 102 in communication with one or more user devices 104. It is appreciated that one or more details may be explained with reference to a ‘user device 104’ of the one or more user devices, and the details are equally applicable for each of the one or more user devices. In an example, the system 200 may be accessed by the user device 104 via an application installed in the user device 104 and/or as a Software as a Service (SaaS) application. The server 102 and the user device 104 may be in communication with each other. In an example, the server 102 and the user device 104 may be in communication via a network for communicating any data over the network to the system 102. The network may include wired networks, wireless networks, Ethernet AVB networks, or combinations thereof. The wireless network may be a cellular telephone network, an 802.11, 802.16, 802.20, 802.1Q, or WiMax network. Further, the network may be a public network, such as the Internet, a private network, such as an intranet, or combinations thereof, and may utilize a variety of networking protocols now available or later developed including, but not limited to TCP/IP based networking protocols.

In an embodiment, the user device 104 may be configured to provide a user interface to a user 110 for performing a user interaction with the social networking environment 106 via the application or/and as the SaaS application. The user device may include, but is not limited to, a tablet PC, a Personal Digital Assistant (PDA), a mobile-device, a palmtop computer, a laptop computer, a desktop computer, a server, a cloud server, a remote server, a communications device, a wireless-telephone, or any other machine controllable through the wireless-network and capable of executing a set of instructions (sequential or otherwise) that specify actions to be taken by that machine.

Further, the social networking environment 106 may indicate an online platform or digital space where the user 110 may connect, interact, and engage with other users based on shared interests, relationships, or activities. The social networking environment 106 may provide a virtual community that enables the user 110 to build and maintain social connections, exchange information, and participate in various forms of communication. The user 110 in the social networking environment 106, may create a user profile or a user account that represents the user's 110 online identity. The user profile often includes personal information, such as a user's name, profile picture, and background details. In the example, the user 110 may interact with the social networking environment 106 via the user feed 108. The user feed 108 may indicate an activity feed, which may constitute an important part of the social networking environment 106. The user feed 108 may further indicate a constantly updating stream of the content tailored to the user's 110 interests and preferences. Thus, each of the user profile may have a corresponding user feed 108. Further, the user feed 108 may typically display a variety of information or the content, such as posts, updates, photos, videos, articles, and other relevant content, based on the activities and connections of the user and their network.

In an example, the user interaction may indicate various ways in which the user 110 may engage, communicate, and interact with the user feed 108, other users, and the social networking environment 106, respectively. The user interaction may include actions and behaviors of the user 110 within the social networking environment 106. In the example, the user interaction may include:
a) Posting and Sharing: The user 110 may create and share the content such as text, photos, videos, and links on their own profiles or in groups and communities.
b) Liking and Reacting: The user 110 may express their appreciation or approval of the user feed 108 such as posts, comments, or other content by liking, reacting, or using similar engagement features provided by the social networking environment 106.
c) Commenting: The user 110 may leave comments on the user feed 108. Thus, the user 108 may engage in conversations and discussions with the original poster and other users.
d) Following and Connecting: The user 110 may choose to follow or connect with other users, thereby establishing a mutual connection and enabling them to see each other's updates and activities.
e) Messaging: The user 110 may communicate privately with other users through direct messages or private messaging features.
f) Tagging and Mentioning: The user 110 may tag or mention other users in their posts or comments, bringing their attention to specific content or inviting them to participate in a conversation.
g) Sharing and Reposting: The user 110 may share or repost the content created by others, allowing it to be seen by their own network of followers or connections.

In an embodiment, the content displayed on the user feed 108 associated with the user profile may be customized based on a user interest. The server 102 may be configured to customize the content based on the user interest and transmit it to the social networking environment 106 such that the customized content may be displayed on a user interface of the user device 104. Thus, the user 110 may be able to perform user interaction with the customized content being displayed in the user feed 108.

Referring to FIG. 2a which illustrates a block diagram of the system 200, according to an embodiment of the present disclosure, the system 200 may include, but is not limited to, a processor 202, memory 204, modules 206, and data 208. The modules 206 and the memory 204 may be coupled to the processor 202.

The processor 202 can be a single processing unit or several units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is adapted to fetch and execute computer-readable instructions and data stored in the memory 204. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulates signals based on operational instructions.

Further, the modules 206 can be implemented in hardware, instructions executed by a processing unit, or by a combination thereof. The processing unit can comprise a computer, a processor, such as the processor 202, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 206 may be machine-readable instructions (software) which, when executed by a processor/processing unit, perform any of the described functionalities.

FIG. 2b illustrates another schematic block diagram of the modules 206 of the system 200 for customizing the content on the user feed 108, according to an embodiment of the present disclosure. In an embodiment, the modules 206 may include an intelligent module 210, a review module 212, a filtering module 214, a recommendation module 216, a wallet module 218, a profile module 220, a report content module 222, a weightage computation module 224, a text module 226, and a post feed module 228. The intelligent module 210, the review module 212, the filtering module 214, the recommendation module 216, the wallet module 218, the profile module 220, the report content module 222, the weightage computation module 224, the text module 226, and the post feed module 228 may be in communication with each other. The data 208 serves, amongst other things, as a repository for storing data processed, received, and generated by one or more of the modules 206. In another embodiment of the present disclosure, the processor 202 includes the modules 206, and the processor 202 via the modules 206 is configured to execute machine-readable instructions (software) which perform the working of the system 200 within the scope of the present invention as described in forthcoming paragraphs.

Referring to FIG. 1, FIG. 2a, and FIG. 2b, the system 200 may be configured to customize the content on the user feed 108 associated with the user profile in the social networking environment 106.

In an embodiment, the profile module 220 may be configured to receive a configuration request from the user device 104 of the user 110. The configuration request may indicate a request for interaction with the social networking environment 106. The interaction may be accomplished via a request for creating the user profile associated with the user 110 on the social networking environment 106. Thus, the profile module 220 may be configured to transmit to the user device 104, a registration of the user profile in response to receiving the configuration request from the user device 104.

Further, the profile module 220 may be configured to provide a pre-defined set of questions along with the creation of the user profile associated with the user 110 on the social networking environment 106. Thus, the profile module 220 may be configured to obtain a response to the pre-defined set of questions from the user 110 during the registration of the user profile. In a non-limiting example, the set of questions may include ‘What is a username’, ‘What is a user location’, ‘What is a user interest subject’, ‘What is a user preferred language’, and alike. The user 110 via the user interface of the user device 104 provides response to the pre-defined set of questions as a prerequisite step for registration of the user profile. The profile module 220 may be in communication with the intelligent module 210.

In an embodiment, the intelligent module 210 may be configured to determine a set of parameters associated with the user profile, based on the response of the pre-defined set of questions from the user 110, during the registration of the user profile. The set of parameters may indicate a plurality of factors which customize the content displayed according to each individual user's interests and preferences. In an example, the set of parameters may include one or more of a user behavior, a user preferences and settings, social connections, a content relevance based on topic, keywords, and metadata, a user historical interactions, a user location and context, a user device type, a user browsing history, a user demographic information, and a user advertiser preferences.

Further, the intelligent module 210 may be configured to determine a user interest associated with the user profile based on the set of parameters for customizing the user feed 108. In an example, the user interest may indicate a content type for promoting the user interaction with the user feed 108 associated with the social networking environment 106. In the example, the user interest refers to the specific topics, subjects, or types of content that may capture the attention and engagement of the user 110 while performing the user interaction with the social networking environment 106. The user interest may reflect the user's preferences, hobbies, passions, and areas of curiosity. In one example, the user 110 may provide a response to ‘what is a user interest subject’ as ‘sports’. Further, the user behavior and the user preferences may also indicate users' inclination towards the category of ‘sports’ based on videos watched by the user, the browsing history, the and the user's historical interactions. Thus, in the example, the intelligent module 210 may be configured to determine the user interest in the ‘sports’ category.

Further, the intelligent module 210 may be configured to correlate the user interest and the content in the social networking environment 106. In an example, the social networking environment 106 may include a pool of the content uploaded by multiple users. The intelligent module 210 may be configured to determine a relationship between the user interest and the pool of the content uploaded by multiple users. In one example, if the user interest may include ‘sports’, then the intelligent module 210 may be configured to associate the ‘sports’ category with the pool of the content.

Further, the intelligent module 210 may include an AI module. The AI module may include a plurality of neural network layers. Examples of neural networks include but are not limited to, convolutional neural network (CNN), deep neural network (DNN), recurrent neural network (RNN), and Restricted Boltzmann Machine (RBM). The learning technique is a method for training a predetermined target device (for example, a robot, or the server) using a plurality of learning data to cause, allow, or control the target device to make a determination or prediction. Examples of learning techniques include, but are not limited to, supervised learning, unsupervised learning, semi supervised learning, or reinforcement learning. At least one of a plurality of CNN, DNN, RNN, RMB models and the like may be implemented to thereby achieve execution of the present subject matter's mechanism through an AI model. A function associated with AI may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning. The profile module 220 and the intelligent module 210 may be in communication with the recommendation module 216.

In an embodiment, the recommendation module 216 may be configured to determine the customized content corresponding to the user profile, based on the correlation such that the customized content is selected from the content or the pool of the content in the social networking environment 106 in association with the user interest. In one example, as the determined user interest is in the ‘sports’ category, the recommendation module 216 may be configured to customize the content related to the ‘sports’ category.

Further, the recommendation module 216 may be configured to display the customized content on the user feed associated with the user profile. In one example, the user feed may display news, videos, or any other content related to the ‘sports’ category. In one example, the user feed may be updated based on the customized content.

Further, the recommendation module 216 may include the AI module. The AI module may include a plurality of neural network layers. Examples of neural networks include but are not limited to, convolutional neural network (CNN), deep neural network (DNN), recurrent neural network (RNN), and Restricted Boltzmann Machine (RBM). The learning technique is a method for training a predetermined target device (for example, a robot, or the server) using a plurality of learning data to cause, allow, or control the target device to make a determination or prediction. Examples of learning techniques include, but are not limited to, supervised learning, unsupervised learning, semi-supervised learning, or reinforcement learning. At least one of a plurality of CNN, DNN, RNN, RMB models and the like may be implemented to thereby achieve execution of the present subject matter's mechanism through an AI model. A function associated with AI may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). One or a plurality of processors control the processing of the input data in accordance with a predefined operating rule or artificial intelligence (AI) model stored in the non-volatile memory and the volatile memory. The predefined operating rule or artificial intelligence model is provided through training or learning. The profile module 220, the intelligent module 210, and the recommendation module 216 may be in communication with the review module 212 and the filtering module 214.

In an embodiment, the review module 212 may be configured to receive a modification input via the user interaction with the customized content. In an example, the modification input includes one or more of a content blocking requests, a change in the set of parameters request, and a content reporting. Further, the filtering module 214 may be configured to receive the modification input from the review module 212 and filter the customized content on the user feed based on the modification input.

The review module 212 may be configured to update the customized content corresponding to the user profile, based on the modification input, and display the updated customized content on the user feed. In one example, the user 110 may provide the modification input as the content blocking request for a particular sub-category of ‘sports’ such ‘basketball’. Thus, the filtering module 214 may remove the content related to ‘basketball’ from the user feed and the review module 212 may be configured to display the updated customized content without displaying the content related to ‘basketball’.

In an embodiment, the review module 212 may be in communication with the report content module 222. The report content module 222 may be configured to receive the modification request including the content blocking request. In an example, the report content module 222 may be configured to communicate the content blocking request to the review module 212 for updating the customized content.

In an embodiment, the review module 212 may be configured to monitor a user action in the social networking environment 106. In an example, the user action comprises one or more of a total number of clicks on the customizable content, a total time spent on the customizable content, and a total number of uploaded content associated with the user profile. The profile module 220, the intelligent module 210, the recommendation module 216, and the review module 212 may be in communication with the weightage computation module 224.

In an embodiment, the weightage computation module 224 may be configured to compute an interest percentage corresponding to the user profile based on the user action. In an example, the interest percentage indicates a weighted computation of the user action. The profile module 220, the intelligent module 210, the recommendation module 216, the review module 212, and the weightage computation module 224 may be in communication with the wallet module 218.

In an embodiment, the wallet module 218 may be configured to allocate at least one reward point to the user profile based on the interest percentage computed by the weightage computation module 224. Thus, the at least one reward point corresponds to the user action performed by the user 110 on the social networking environment 106 such as the total number of clicks on the customizable content, the total time spent on the customizable content, and the total number of uploaded content associated with the user profile. In one example, the at least one reward point may indicate a digital asset.

In an embodiment, the wallet module 218 may be configured to associate a non-fungible token (NFT) and a cryptographic hash value to the user profile based on the user action.

Further, the wallet module 218 may be configured to convert the at least one reward point into a cryptocurrency.

In some embodiments, the functionalities described above with respect to the modules 206 may be provided by the processor 202 in conjunction with the memory 204. In some embodiments, the modules 206 may be provided within the memory 204.

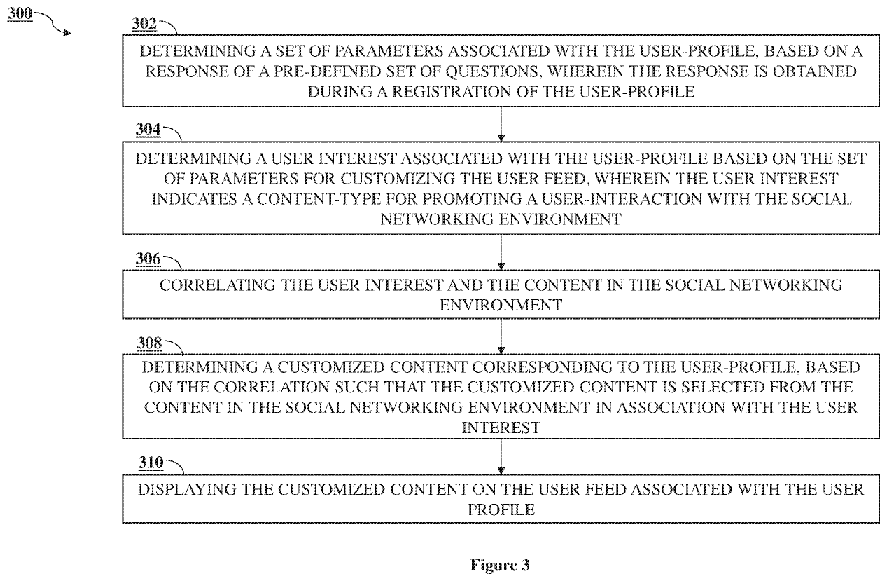

FIG. 3 illustrates a detailed process flow depicting a method 300 for customizing the content on the user feed 108 associated with the user profile in the social networking environment 106, according to an embodiment of the present disclosure. The method 300 may be a computer-implemented method executed, for example, by the system 200. For the sake of brevity, constructional and operational features of the system 200 that are already explained in the description of FIG. 1, FIG. 2a, and FIG. 2b, are not explained in detail in the description of FIG. 3.

At step 302, the method 300 may include determining the set of parameters associated with the user profile, based on the response of the pre-defined set of questions from the user associated with the user feed, during a registration of the user profile.

At step 304, the method 300 may include determining the user interest associated with the user profile based on the set of parameters for customizing the user feed. The user interest indicates the content type for promoting the user interaction with the user feed associated with the social networking environment 106.

At step 306, the method 300 may include correlating the user interest and the content in the social networking environment 106.

At step 308, the method 300 may include determining the customized content corresponding to the user profile, based on the correlation such that the customized content is selected from the content in the social networking environment in association with the user interest.

At step 310, the method 300 may include displaying the customized content on the user feed associated with the user profile.

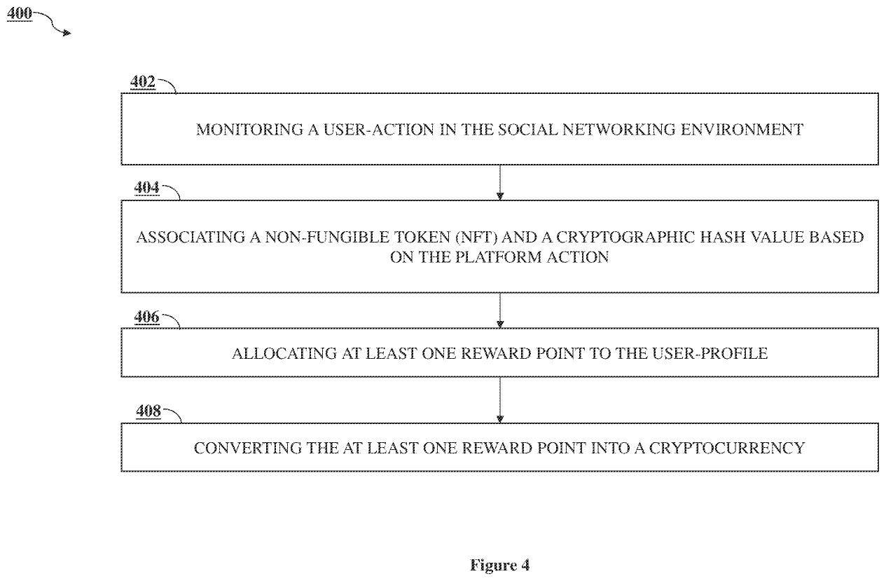

FIG. 4 illustrates a detailed process flow depicting a method 400 for converting at least one reward point into the cryptocurrency, according to an embodiment of the present disclosure.

At step 402, the method 400 may include monitoring the user action in the social networking environment 106. The user action comprises one or more of the total number of clicks on the customizable content, the total time spent on the customizable content, and the total number of uploaded content associated with the user profile.

At step 404, the method 400 may include associating the non-fungible token (NFT) and the cryptographic hash value to the user profile based on the user action.

At step 406, the method 400 may include allocating at least one reward point to the user profile.

At step 408, the method 400 may include converting the at least one reward point into the cryptocurrency.

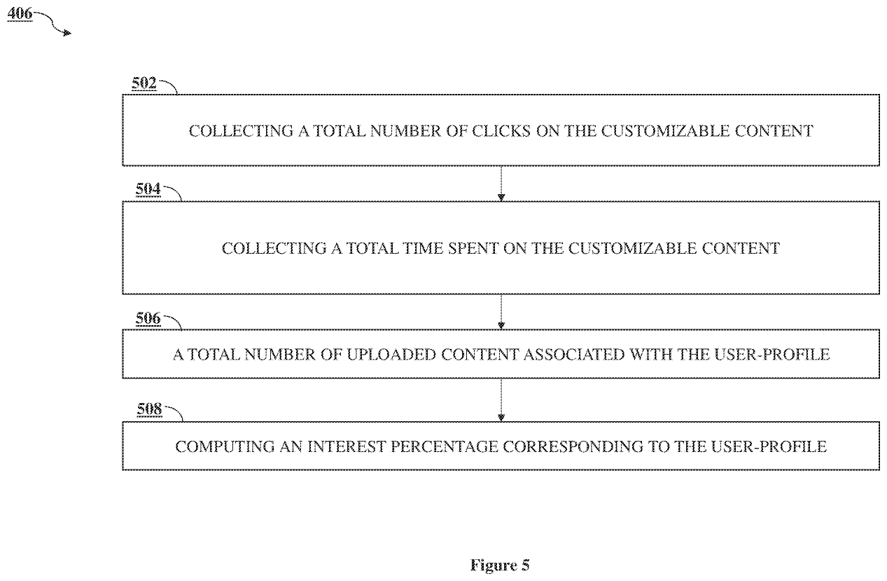

FIG. 5 illustrates a detailed process flow comprising sub-steps of the method step 406 for computing the interest percentage corresponding to the user profile, according to an embodiment of the present disclosure.

At sub-step 502, the method step 406 may include collecting the total number of clicks on the customizable content.

At sub-step 504, the method step 406 may include collecting the total time spent on the customizable content.

At sub-step 506, the method step 406 may include collecting the total number of uploaded content associated with the user profile.

At sub-step 508, the method step 406 may include computing the interest percentage corresponding to the user profile based on the user action such as the total number of clicks on the customizable content, the total time spent on the customizable content, and the total number of uploaded content associated with the user profile.

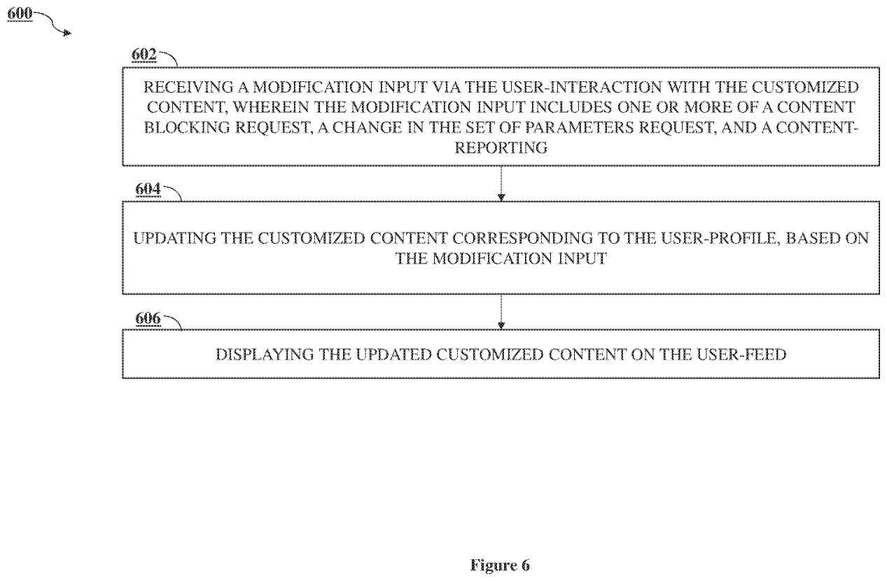

FIG. 6 illustrates a detailed process flow depicting a method 600 for displaying the updated customized content on the user feed, according to an embodiment of the present disclosure.

At step 602, the method 600 may include receiving the modification input via the user interaction with the customized content, wherein the modification input includes one or more of a content blocking request, the change in the set of parameters request, and the content reporting.

At step 604, the method 600 may include updating the customized content corresponding to the user profile, based on the modification input.

At step 606, the method 600 may include displaying the updated customized content on the user feed.

The methods depicted in FIGS. 4-6 may be a computer-implemented methods executed, for example, by the system 200. For the sake of brevity, constructional and operational features of the methods depicted in FIGS. 4-6 that are already explained in the description of FIG. 1, FIG. 2a and FIG. 2b, are not explained in detail in the description of methods depicted in FIGS. 4-6.

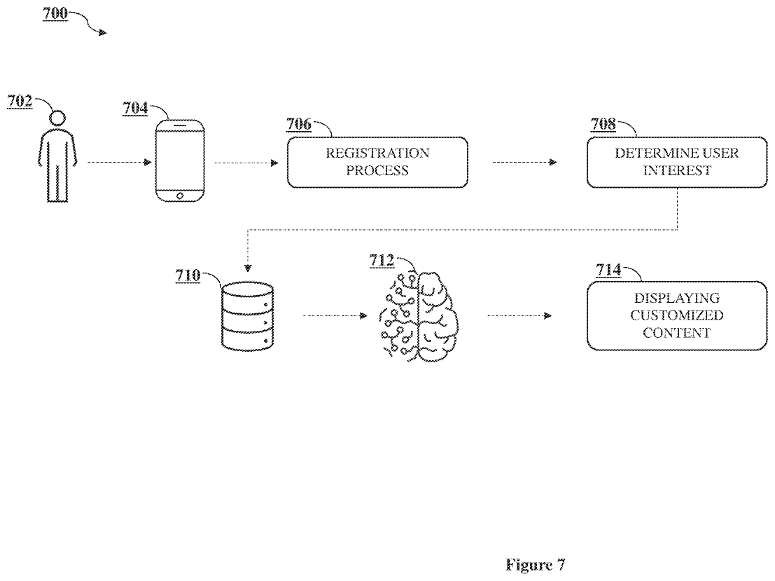

FIG. 7 illustrates an exemplary process flow comprising a method 700 for displaying the customized content on the user feed 108 associated with the user profile in the social networking environment 106, according to an embodiment of the present disclosure.

At step 702, the method 700 may include the user 110 intending to perform user interaction with the social networking environment 106.

At step 704, the method 700 may include configuring the user device 104 with the server 102 to register the user profile.

At step 706, the method 700 may include registering the user profile with the server 102.

At step 708, the method 700 may include determining the user interest associated with the user profile based on the set of parameters for customizing the user feed.

At step 710, the method 700 may include storing the user interest in the memory 204 at the server 102.

At step 712, the method 700 may include correlating the user interest and the content in the social networking environment via the AI model.

At step 714, the method 700 may include determining the customized content, via the AI model, corresponding to the user profile, based on the correlation such that the customized content is selected from the content in the social networking environment in association with the user interest. Further, displaying the customized content on the user feed associated with the user profile.

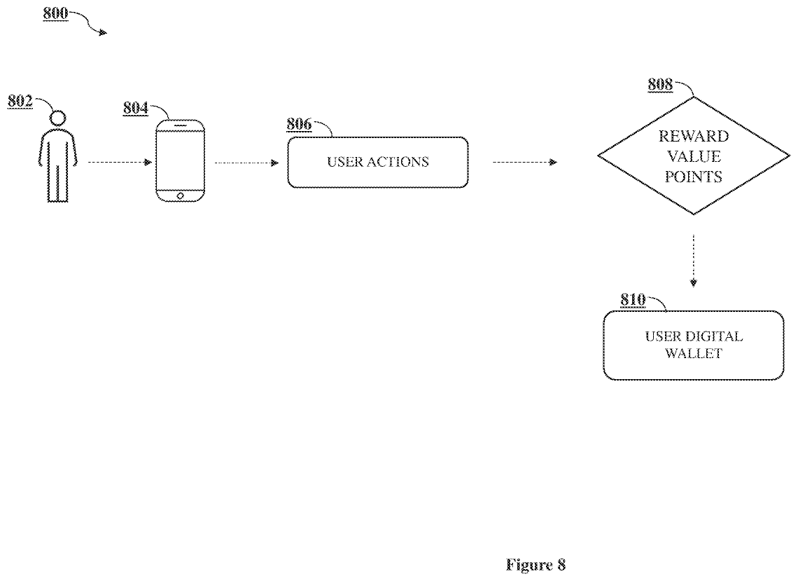

FIG. 8 illustrates an exemplary process flow comprising a method for converting the at least one value point into a digital currency, according to an embodiment of the present disclosure.

At step 802, the method 800 may include the user 110 intended to perform user interaction with the social networking environment.

At step 804, the method 800 may include the user 110 using the user device 104 to perform user interaction.

At step 806, the method 800 may include monitoring the user action in the social networking environment, wherein the user action comprises one or more of the total number of clicks on the customizable content, the total time spent on the customizable content, and the total number of uploaded content associated with the user profile.

At step 808, the method 800 may include allocating at least one reward point to the user profile.

At step 810, the method 800 may include converting the at least one reward point into the cryptocurrency and storing in the digital wallet associated with the user profile.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method for customizing content on a user feed associated with a user profile in a social networking environment, the method comprising:
determining a set of parameters associated with the user profile, based on a response of a pre-defined set of questions from a user associated with the user feed, during a registration of the user profile;
determining a user interest associated with the user profile based on the set of parameters for customizing the user feed, wherein the user interest indicates a content type for promoting a user interaction with the user feed associated with the social networking environment;
correlating the user interest and the content in the social networking environment;
determining a customized content corresponding to the user profile, based on the correlation such that the customized content is selected from the content in the social networking environment in association with the user interest; and
displaying the customized content on the user feed associated with the user profile.

2. The method of claim 1, wherein prior to determining the set of parameters, the method comprises:
receiving a configuration request from a user device (UD) of the user associated with the user profile, wherein the configuration request indicates a request for interaction with the social networking environment; and
transmitting registration of the user profile in response to receiving the configuration request.

3. The method of claim 1, further comprising:
monitoring a user action in the social networking environment, wherein the user action comprises one or more of a total number of clicks on the customizable content, a total time spent on the customizable content, and a total number of uploaded content associated with the user profile;
computing an interest percentage corresponding to the user profile based on the user action, wherein the interest percentage indicates a weighted computation of the user action; and
allocating at least one reward point to the user profile based on the interest percentage.

4. The method of claim 3, further comprising: associating a non-fungible token (NFT) and a cryptographic hash value to the user profile based on the user action.

5. The method of claim 3, further comprising: converting the at least one reward point into a cryptocurrency.

6. The method of claim 1, wherein correlating the user interest and the content in the social networking environment comprises correlating the user interest and the content based on an AI model.

7. The method of claim 1, wherein determining the customized content corresponding to the user profile comprises determining the customized content corresponding to the user profile based on an AI model.

8. The method of claim 1, further comprising:
receiving a modification input via the user interaction with the customized content, wherein the modification input includes one or more of a content blocking request, a change in the set of parameters request, and a content reporting;
updating the customized content corresponding to the user profile, based on the modification input; and
displaying the updated customized content on the user feed.

9. A system for customizing content on a user feed associated with a user profile in a social networking environment, the system comprising:
a memory;
at least one processor in communication with the memory, the at least one processor being configured to:
determine a set of parameters associated with the user profile, based on a response of a pre-defined set of questions from a user associated, with the user feed, during a registration of the user profile;
determine a user interest associated with the user profile based on the set of parameters for customizing the user feed, wherein the user interest indicates a content type for promoting a user interaction with the user feed associated with the social networking environment;
correlate the user interest and the content in the social networking environment;
determine a customized content corresponding to the user profile, based on the correlation such that the customized content is selected from the content in the social networking environment in association with the user interest; and
display the customized content on the user feed associated with the user profile.

10. The system of claim 9, wherein prior to determining the set of parameters, the at least one processor is configured to:
receive a configuration request from a user device (UD) of the user associated with the user profile, wherein the configuration request indicates a request for interaction with the social networking environment; and
transmit registration of the user profile in response to receiving the configuration request.

11. The system of claim 9, the at least one processor further is configured to:
monitor a user action in the social networking environment, wherein the user action comprises one or more of a total number of clicks on the customizable content, a total time spent on the customizable content, and a total number of uploaded content associated with the user profile;
compute an interest percentage corresponding to the user profile based on the user action, wherein the interest percentage indicates a weighted computation of the user action; and
allocate at least one reward point to the user profile based on the interest percentage.

12. The system of claim 11, the at least one processor further is configured to: associate a non-fungible token (NFT) and a cryptographic hash value to the user profile based on the user action.

13. The system of claim 11, the at least one processor further is configured to: convert the at least one reward point into a cryptocurrency.

14. The system of claim 9, wherein to correlate the user interest and the content in the social networking environment the at least one processor further is configured to: correlate the user interest and the content based on an AI model.

15. The system of claim 9, wherein to determine the customized content corresponding to the user profile the at least one processor further is configured to: determine the customized content corresponding to the user profile based on an AI model.

16. The system of claim 9, the at least one processor is further configured to:
receive a modification input via the user interaction with the customized content, wherein the modification input includes one or more of a content blocking request, a change in the set of parameters request, and a content reporting;
update the customized content corresponding to the user profile, based on the modification input; and
display the updated customized content on the user feed.
